(19) United States
(12) Patent Application Publication
(10) Pub. No.: US 2011/0309228 A1
(43) Pub. Date: Dec. 22, 2011

(54) Product-Lifting Display and Merchandising System

(75) Inventors: George COX, Hamburg, PA (US); John FARINOLA, Monroe Township, NJ (US); Charles BABBONI, Roseland, NJ (US)

(73) Assignee: Trinity, LLC, Metuchen, NJ (US)

(21) Appl. No.: 13/163,362

(22) Filed: Jun. 17, 2011

Related U.S. Application Data
(60) Provisional application No. 61/355,743, filed on Jun. 17, 2010.

(51) Int. Cl. A47F 3/06; A47F 5/10; F16M 11/24

(52) U.S. Cl. 248/573; 211/1.57

(57) ABSTRACT

A product-lifting display and merchandising system is provided which includes a bottom platform formed of solid molded plastic and having one or more feet extending from an underside surface thereof A top deck has a planar horizontal upper surface for supporting a quantity of stacked product thereon. One or more movable support members are connected between the bottom platform and the top deck for dynamically adjusting a vertical position of the top deck relative to the bottom platform. There is a compression member positioned between the bottom platform and the top deck. The compression member supplies a lifting force to the top deck in opposition to a weight of the stacked product. As the weight of the stacked product is reduced due to gradual removal by consumers, the top deck rises to maintain a top layer of the stacked product at a determined height for ease of accessibility by the consumers.

### CROSS-REFERENCE TO RELATED APPLICATIONS

This application claims the benefit of U.S. Provisional Patent Application No. 61/355,743, filed on Jun. 17, 2010, which is hereby incorporated by reference in its entirety.

### BACKGROUND OF THE INVENTION

1. Filed of the Invention

This invention relates to the field of product merchandising displays and, more particularly, to a product display for automatic adjustment of the height of product positioned on the display.

2. Description of the Related Art

Conventional retail displays may be based on an arrangement of pallets stacked with product. The term “product” is used in certain instances herein in the singular form, as is common in the industry, to refer to a quantity of individual containers of a particular product, e.g., bags of pet food, cans of soup, bottles of soda, etc. The pallets may be taken directly from a warehouse or storage room and positioned in a retail aisle using a pallet lifter or forklift. However, such arrangements of product may not be well-suited as a retail display for a number of reasons. For example, these arrangements may result in visual clutter, may be hard for shoppers to navigate, and may provide poor brand identity. Also, splintered and broken pallets which are not skirted may create a potential safety hazard.

Furthermore, retail aisles containing pallets of product may make it inconvenient to shop and access product, especially with heavier merchandise, during “sell down,” i.e., as the height of the stack of product is reduced through purchases by shoppers. A conventional pallet of product, as it sells down, causes the shopper to have to stoop significantly to the bottom of the pallet to reach and lift the top-most product or causes the store associate to have to bend down to reload product on the pallet. For heavy product, such as large bags of pet food, beverage products, and bulk-sized tubs and bags of various other products, a pallet-based display may make shopping and stocking much more strenuous and can negatively affect sales of such product. Such display arrangements may increase in-store labor requirements and may also increase the possibility of back injuries by store associates and customers.

### SUMMARY OF THE INVENTION

The disclosed embodiments provide a pallet-lifting display and merchandising system for a product merchandiser which allows for easier purchase of pallet-presented product at mass retail locations. The disclosed embodiments provide easier loading of product and better inventory management of pallet-based product. A pallet of heavier product (or hand-stacked product without a pallet) such as, for example, bags of dog food, soda, water, beer, canned product, and other products of similar density may be placed on the disclosed lifting assembly, which raises the product to allow it to be purchased from the top of the pallet, or decking when product is hand stacked, at a height just above the protective graphic side panels and allows the pallet or deck to be easily loaded at waist-level. This is achievable because as the product is purchased, the weight on the pallet decreases, a compression member such as a spring or springs thus expand vertically, and the pallet gradually rises so that the top product is always at an easily purchasable, loadable, and visible height. The height of the platform, or deck, upon which the pallet is placed may be set to any desired level by proper selection of the spring characteristics, depending upon the weight and arrangement of the product.

The disclosed embodiments include a structural metal, molded plastic, or wood deck upon which the pallet of product (or hand stacked product) rests. The disclosed lifting assembly may be implemented with a single deck or with multiple decks that lift independently. At one end of the deck, there may be a pallet guide stop (e.g., a metal flange) that extends a few inches above the deck. This flange allows a forklift operator to more easily position the pallet of product flush with the end of the deck. There may also be guides on the sides of the deck to ensure proper alignment of the pallet on the deck.

The deck may be supported by one or more compression springs and metal cross-braces, which may have wheels that roll on a track within the base or guide pins that locate them in a lower track or slot on the base. As weight is put on the deck by loading of product thereon, as the spring compresses, the ends of the cross-braces travel along the track on the base (or the guide pins travel within the track or slot), thereby allowing for a continuous lowering of the deck as product is continued to be loaded, and likewise a continuous raising of the deck as product is purchased and removed from the deck. The height of the deck can be set to any desired level through proper selection of the spring characteristics (and quantity) based on product weight requirements. There may also be a feature to allow the height of the deck to be adjusted by in-store personnel, e.g., by including adjustable air compression cylinders in addition to springs. Alternatively, or in addition, a lever or dial mechanism may be provided which allows adjustment of the spring position so as to effectively change the spring rate and/or initial compression. For example, the adjustment mechanism may move one end of the spring vertically or laterally, thereby changing the compression properties (e.g., a lever with multiple latching positions could be used to raise the bottom end of the spring to increase compression). In addition, an incremental pin stop may be provided which would allow store personnel to set the lifting stop height to different positions.

The heavy duty lifting structure of the disclosed embodiments may be covered on all four sides, or fewer than four sides, by a skirt formed, for example, of decorative plastic, metal, or wood panels that is printed with indicia or that has a sign-holding mechanism which can hold brand, retailer, and/or promotional graphics. The decorative sides may be attached to each other or to the lifting assembly. In one or more corners, the covers may be unattached from one another, thereby allowing one end to be pulled back so the graphic/protective structure can be moved away from the lifting assembly. This allows a fork lift to come in from any direction (the base is designed to allow 4-way entry for lifting) to either load the lifting assembly or take a pallet off of the lifting assembly. Once this action takes place, the graphic skirt can be easily be put back in place around the lifting assembly and pallet offering. A track may be provided at the bottom of the lifting assembly into which an edge of the graphic skirt attaches to allow the graphic skirt to easily slide back into place.

In another embodiment the skirt may have a window, opening, or transparent section that allows for easy viewing of the product inventory that is otherwise concealed by the skirt to allow store personnel to ascertain when product restocking should occur.

The disclosed embodiments may also have the ability to accept add-on features, such as safety straps, as needed, communication headers, as well as various cross-merchandising features (e.g., shelves installed above the product and product-holding mechanisms that attach to the sides of the lifting assembly). Notably, while a forklift is typically used to load the product onto the lifting assembly, a pallet jack is all that is needed to transport the loaded lifting assembly from a backroom to the sales floor, or anywhere else in the store.

The disclosed embodiments allow for creation of a full-size 48″×40″ (typical pallet size) lifting assembly, but the disclosed features may also be applied to smaller pallet sizes, as well as smaller display sizes. In addition, a lifting assembly may be installed as the base shelf in a standard retail shelf (referred to as a “gondola”) so as to lift product on base (i.e., bottom) decks, especially in the case of mass retail “end caps,” which are positioned at the ends of a gondola.

The disclosed embodiments may also be used in a “horizontal” configuration for certain heavy product circumstances, e.g., tires, whether on pallets or on some form of shelving. In such cases, the lifting assembly may be installed to operate at an incline such that a portion of the weight of the product is translated to the lifting assembly. Such an arrangement allows for continuous near-horizontal movement of the product as the product is removed, without requiring significant compression force on the product (as in the case in which product is compressed against a front stop of the display unit).

The disclosed embodiments provide a display configuration which elevates brand presentation, eliminates “visual out-of-stocks,” i.e., the appearance of a product being sold out or nearly sold out, makes it more convenient to slide heavy product from a pallet onto a shopping cart, and reduces risk of injury by eliminating reaching down to the bottom of a pallet to access and reload product. The disclosed embodiments may also provide an advertising billboard on a skirt for interchangeable brand messaging. The disclosed embodiments provide a lifting assembly that is light-weight and portable—the lifting assembly is easily moved from back room to sales floor using a standard pallet jack. A pallet jack or forklift may be used to transport the lifting assembly from any side due to the footed configuration of the base of the lifting assembly.

Accordingly, the embodiments disclosed herein provide a product-lifting display and merchandising system including a bottom platform formed of molded plastic and having one or more feet extending from an underside surface thereof The bottom platform has a mounting surface formed in a top surface thereof. The system further includes a top deck having a planar horizontal upper surface for supporting a quantity of stacked product thereon. The top deck has a mounting surface formed in an underside surface thereof The system further includes a movable support member connected between the bottom platform and the top deck for dynamically adjusting a vertical position of the top deck relative to the bottom platform. There is at least one compression member having a first end seated at the mounting surface of the bottom platform and a second end seated at the mounting surface of the top deck. The compression member supplies a lifting force to the top deck in opposition to a weight of the stacked product. As the weight of the stacked product is reduced due to gradual removal of the stacked product, such as by consumers, the top deck rises to maintain a top layer of the stacked product at a determined height for ease of accessibility by the consumers.

Other objects and features of the present invention will become apparent from the following detailed description considered in conjunction with the accompanying drawings. It is to be understood, however, that the drawings are designed solely for purposes of illustration and not as a definition of the limits of the invention. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The above and other objects and advantages of the disclosed subject matter will be apparent upon consideration of the following detailed description, taken in conjunction with accompanying drawings, in which like reference characters refer to like parts throughout, and in which:

FIG. 1 is a perspective view of a lifting assembly in accordance with the disclosed embodiments.

FIG. 2 is a side view of the lifting assembly of FIG. 1.

FIG. 3 is a front view of the lifting assembly of FIG. 1.

FIG. 4 is a perspective view of a product-lifting display and merchandising system in accordance with the disclosed embodiments.

FIG. 5 is a rear view of the product-lifting display and merchandising system of FIG. 4 with the rear skirt panel removed.

FIG. 6 is a perspective view of a gondola end cap having a lifting assembly installed on the bottom deck thereof.

### DETAILED DESCRIPTION OF THE PREFERRED EMBODIMENTS

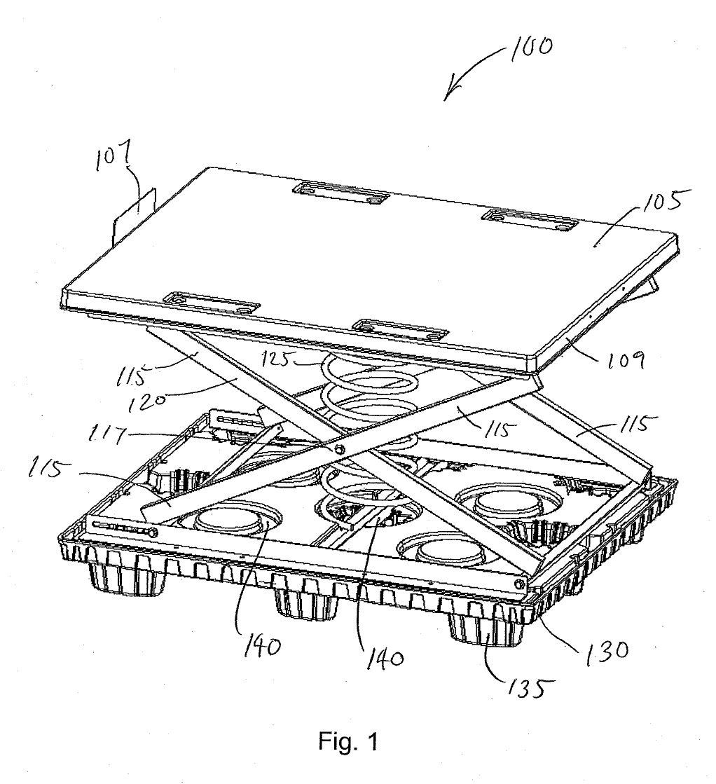

The embodiments described herein provide a product-lifting display and merchandising system. The system is formed primarily of a lifting assembly 100, as depicted in FIGS. 1-3, which lifts product continuously as it is purchased, so as to maintain an appropriate vertical position of the product to allow for easy loading and unloading of the product from the lifting assembly 100, as described in further detail below.

The lifting assembly 100 of FIGS. 1-3 includes a top platform or “deck” 105 having a flat surface for receiving product for display and merchandising. The product may be stacked on a pallet, in which case the pallet may be lifted, e.g., using a forklift, and loaded onto the deck 105 of the lifting assembly 100. Alternatively, the product may be hand-stacked on the deck 105 of the lifting assembly 100 if the product is not pallet-based. The deck 105 may have a flange or stop at one end which acts as a backstop 107 for pallet loading to prevent the pallet from being positioned unevenly on the deck 105. There may also be guides (not shown) on one or more sides of the deck 105 which act as guides for the pallet during the loading process. For example, the deck 105 may be wider than the width of the pallet and may have guides or protruding bumpers on the sides of the deck to guide the pallet into position as it is moved toward the backstop 107.

For purposes of the present disclosure, the edge of the deck 105 on which the backstop 107 is positioned may be considered to be the “back” side of the deck 105, with the “front” side 109 being the opposite side and the direction from which the load is placed onto the deck 105. The other two opposing sides of the deck 105 may simply be referred to as “sides”. In practice, the deck 105 may be approached from any direction for loading, but a side having a guide or backstop 107 typically would not be used as a loading side.

The deck 105 may be supported by an arrangement of one or more support members, such as pairs of pivoting cross-braces 120, and a compression member, such as a spring 125. Each cross-brace 120 may include a pair of rigid members 115 connected at their center points by a pivot connection 117 that allows the members 115 to rotate with respect to one another. The cross-braces 120 may be positioned on either side of the deck 105, with the spring 125 positioned in the center of the deck 105. There may be more than one spring, as discussed in further detail below. Also, there may be additional cross-braces on the front and back sides of the deck 105, depending upon load requirements.

The spring 125 and cross-braces 120 are affixed to a bottom support platform 130, which may be a planar element with a number of feet 135 extending from the bottom surface thereof The platform 130 may be a solid element composed of plastic, e.g., polyethylene, and may be fabricated using a vacuum forming process. The feet 135 allow the platform 130 to be elevated above the floor to allow a forklift or pallet jack to be inserted under the platform 130 to lift and move the assembly 100. The configuration of the feet 135 allows for the assembly 100 to be lifted from any one of its four sides. The use of a molded plastic bottom support platform 130 provides a light-weight, low cost structure which has sufficient strength to support the desired range of loads. Alternatively, the bottom support platform may be formed of metal and may have feet or slots positioned on the underside thereof to allow for lifting of the assembly.

As shown in FIG. 1, the molded plastic bottom support platform 130 may include a number of receptacles 140 formed on the upper surface thereof which are configured to receive an end of one or more springs. The receptacles 140 hold the spring 125 or springs in place at a desired position relative to the platform 130 and may be used with or without adhesive and/or fasteners. This configuration allows for a single molded design to be used with single or multiple-spring versions of the lifting assembly and greatly simplifies manufacture and assembly. Similar receptacles may be provided on the underside of the top deck 105 and serve the same purpose, namely to hold the other end of the springs at desired position relative to the top deck 105.

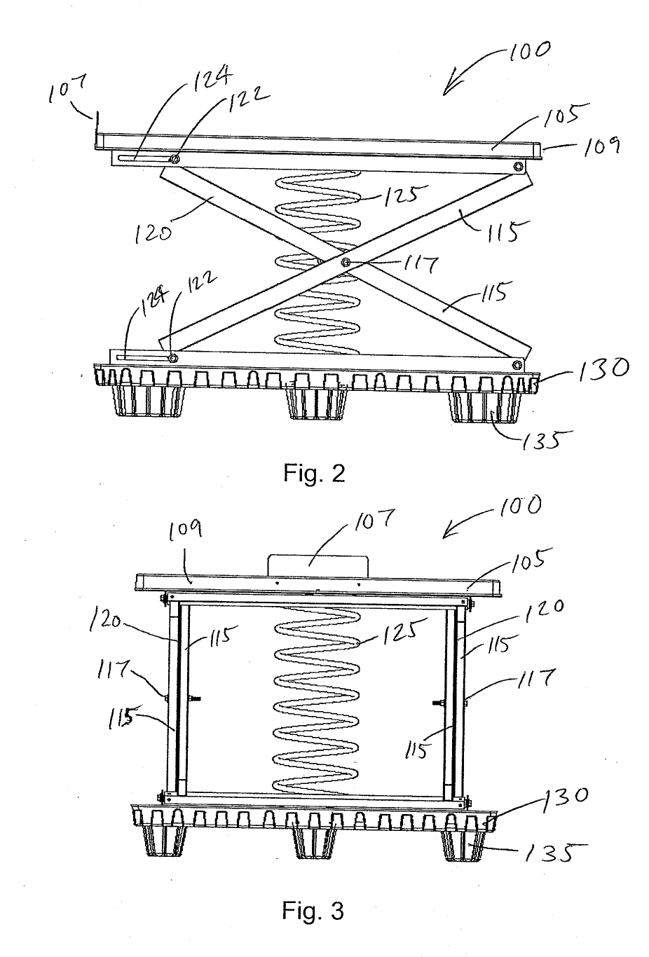

When the deck 105 is loaded with product, it moves downward, thereby compressing the spring 125 and causing the members 115 of the cross-braces 120 to move about their pivot point 117 to assume a more horizontal position in which the members 115 of each cross-brace 120 approach a parallel orientation with respect to one another, i.e., the “X” of the cross brace 120 becomes more flattened. There are numerous ways in which the cross-braces 120 may be connected to allow such movement. As depicted in FIG. 2, for example, a lower end of one of the two members 115 of each cross-brace 120 may have a guide pin 122 or roller positioned in a horizontal slot 124. A similar guide pin 122 or roller and slot 124 arrangement may be used at the upper end of the other member 115 of each cross-brace 120. Alternatively, the slots 124 may both be located at the upper ends of the cross-braces 120 or may both be located at the lower ends of the cross-braces 120. As a further alternative (not shown), the ends of the cross-brace members 115 may have rollers which rest in tracks on the underside of the deck 105 and/or the top surface of the bottom platform 130.

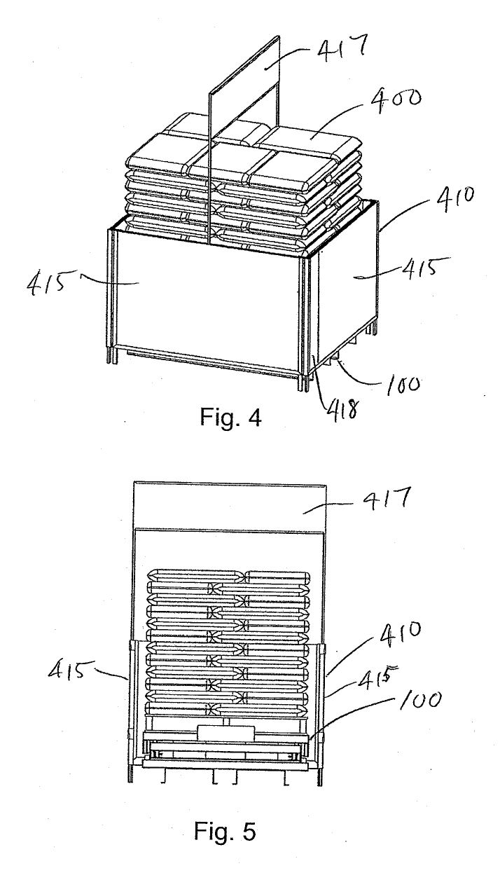

As shown in FIG. 4, a merchandising skirt 410 may be installed around the periphery of the lifting assembly 100. The skirt 410 may by formed of four interconnected panels 415, which may be rectangular metal frames with slots or other fixtures at the ends thereof which allow easy interconnection. The skirt also may be formed of corrugated material. The skirt 410 may, for example, be about 32″ to 36″ tall. The panels 415 may have slots to allow advertising and/or product information to be inserted therein. An overhead panel 417 may be provided to provide additional product information and/or advertising.

As shown in FIGS. 4 and 5, when the lifting assembly 100 is fully loaded with product 400, e.g., bags of dog food, the top deck 105 will move down to its lowest position, because the weight of the product 400 will be greater than the spring force of the compressed spring 125. The deck 105 will be, for example, about 12-14 inches above the floor in this position. Under this fully loaded condition (as shown in FIG. 5), several layers of product 400 are visible above the skirt 410. The exposed layers are thus located at a height of over about 32″ to 36″ (i.e., the height of the skirt). The height of the exposed layers of product 400 is determined so as to provide visibility of the product 400 to show shoppers that it is available, as opposed to appearing to be sold out. The height of the exposed layers of product 400 also provides for convenient removal of product 400 from the stack by shoppers for placement in a shopping cart. The height is also convenient for restocking of the product 400 by store employees.

As product 400 is removed from the top of the stack by shoppers, the total weight of the product 400 on the deck 105 gradually decreases. As this occurs, the spring force will gradually overcome the weight of the product 400 and begin to gradually lift the deck 105 upward. The characteristics of the spring 125 are determined so that the number of exposed layers of product 400 remains approximately the same throughout the “sell down” of the supply of product 400. In other words, as the weight of the stacked product is reduced due to gradual removal of the stacked product by consumers, the deck 105 rises to maintain a top layer of the stacked product at a determined height for ease of accessibility by the consumers. The actual height of the top of the product stack may fluctuate somewhat from the determined height during the sell down, because partial remaining layers of product will decrease the overall product weight density per unit height. Also, there may be hysteresis effects and/or drift in the compression and decompression of the spring 125. Thus, the actual height of the top of the product stack may vary from the determined height by a distance of plus or minus one half product layer, a distance of plus or minus a whole product layer, or more, depending upon circumstances.

At some point, the deck 105 will reach its maximum height, as determined by the maximum position of the cross-braces 120. Several remaining layers of product 400 will be visible above the skirt 410 when the deck 105 is in the maximum position, but then these layers will gradually be sold down to the bare platform, i.e., deck 105, unless the display is restocked in the interim. In a preferred embodiment, a window 418 or slot may be formed in the skirt to show the product level beneath the top of the skirt so that store personnel can readily ascertain when additional product needs to be ordered and/or restocked on the deck 105.

When a spring is compressed, the force it exerts is proportional to its change in length, i.e., displacement. The “rate” or spring constant of a spring is the change in the force it exerts, divided by the displacement of the spring. Most coil springs, as long as they are not compressed beyond their “elastic limit,” obey Hooke's law, which states that the force with which the spring pushes back is linearly proportional to the distance from its equilibrium (i.e., “natural”) length: F=−k·x, where: x is the displacement vector—the distance and direction in which the spring is displaced; F is the resulting force vector—the magnitude and direction of the restoring force the spring exerts; and k is the spring constant or rate of the spring.

The lifting assembly 100 operates by balancing the weight of the product 400 loaded on the deck 105 with the spring force. By selecting the proper rate for the spring 125 relative to a particular product weight profile, the height of the deck 105 can be controlled to keep the total height of the stacked product 400 within a desired range, e.g., a height such that a determined number of layers of product 400 is visible over the top of the skirt 410.

The product weight profile may be defined in terms of density and, more specifically, in terms of product weight per unit of stacked product height, based on a defined product stacking pattern (i.e., the weight of a single layer of product divided by the height of the single layer of product). The stacking pattern may be determined, e.g., by the product supplier, based on the size of the product container relative to the size of a pallet used to ship the product. In the example shown in FIGS. 4 and 5, bags are laid in a flat arrangement on a pallet with five bags per layer (the bags are arranged in an alternating, overlapping stacking arrangement in order to maintain the stability of the product stack on the pallet). If, for example, the product is dry dog food, each layer of the display may contain five 50 lb. bags (for a total of 250 lbs.) and each layer may be, e.g., about 5 inches high. The product weight density (per unit of stacked product height) in this example would be about 50 lb./in. If the spring 125 is to compress about 5 inches as each new layer is added to the product stack (in order to keep the stack height approximately constant), then the spring rate would be chosen to be about 50 lb./in.

When the deck 105 is at its maximum height, which is determined by the maximum movement range of the cross-braces 120, the spring 125 may still be under a determined amount of compression in order to keep a particular number of product 400 layers visible over the top of the skirt 410, e.g., five layers of dog food bags. As the sixth layer of product 400 is added, the deck 105 will begin to lower in order to keep the number of visible layers approximately constant. In this example, five layers of 50 lb. pet food bags (at five bags per layer) weighs 1250 lbs. To establish a compression force of 1250 lb. when the deck 105 is at its maximum height, a 50 lb./in. spring would have to have an initial compression displacement of about 25 inches.

The difference between the maximum height of the deck 105 and the minimum height may be, for example, about 35 inches. Assuming the 50 lb./in. spring 125 is initially compressed by a displacement of about 25 inches, then the maximum compression of the spring 125 will be about 60 inches, resulting in a spring force of about 3000 lbs., which is balanced by twelve layers of dog food bags in the current example. Thus, the deck 105 will remain fixed at its lowest position when twelve or more layers of bags are loaded. As the twelfth layer is removed, the deck 105 will begin its gradual movement upward. It should be noted that the spring compression force is not linear through its entire range of displacement, and the spring rate will increase as the spring approaches its “solid length,” which is the point at which the spring 125 is compressed such that its layers of coil are completely compressed and in direct contact with each other.

The lifting assembly 100 may be preset during manufacture to have a determined spring rate and initial compression force based on the product weight per unit stacking height and the number of visible layers desired, as demonstrated in the preceding example. Alternatively, it is possible to group various products into profile categories based on weight and stacking parameters and to match each profile category to a particular pre-designed model of the lifting assembly with the corresponding spring characteristics. For example, 50 lb. bags of dog food which are stacked with 5 bags per 5 inch layer may be placed in the same product profile category as 25 lb. bags of cat litter which are stacked with 10 bags per 5 inch layer. These products may be placed in the same category, because the product weight per unit stacked product height is the same (50 lb./in.). In this manner, lifting assemblies can be specified in terms of corresponding product profile categories, which obviates the need to individually specify the characteristics of each lifting assembly during manufacture.

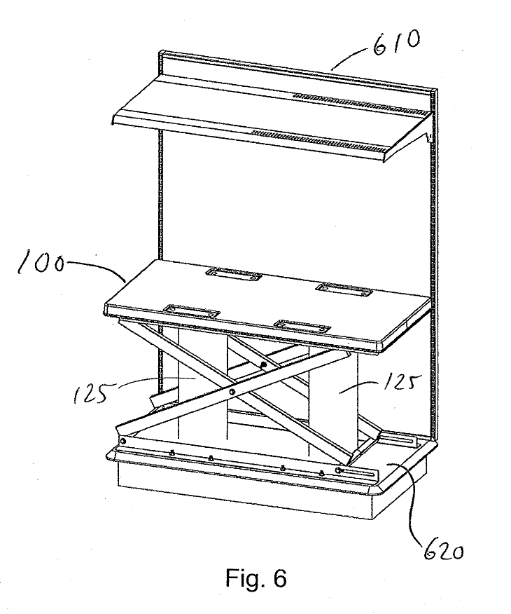

As shown in FIG. 6, the lifting assembly 100 may be incorporated into a traditional retail gondola 610 by installing the assembly 100 on the lower deck 620 of the shelving unit 610 (the springs of the lifting assembly in this example are indicated by rectangular boxes for clarity). This configuration is particularly useful for “end caps” which are displays used at the end of a shelving aisle. In the example of FIG. 6, the lifting assembly 100, without a bottom support platform 130 (see FIG. 1), is attached directly to the lower deck 620. Alternatively, a lifting assembly 100 with a bottom support platform 130 (e.g., as shown in FIG. 1) may be arranged in a gap in the bottom deck 620 (or in lieu of a lower deck in the case of an end cap unit). A skirt 410 may be installed around the front, and possibly the sides, of the lifting assembly in a manner similar to that shown in FIGS. 4 and 5.

Thus, while there are shown, described and pointed out fundamental novel features of the invention as applied to preferred embodiments thereof, it will be understood that various omissions and substitutions and changes in the form and details of the illustrated apparatus, and in its operation, may be made by those skilled in the art without departing from the spirit of the invention. Moreover, it should be recognized that structures shown and/or described in connection with any disclosed form or embodiment of the invention may be incorporated in any other disclosed or described or suggested form or embodiment as a general matter of design choice.

What is claimed is:

1. A product-lifting display and merchandising system comprising:
a bottom platform formed of molded plastic and having one or more feet extending from an underside surface thereof, the bottom platform having a mounting surface formed in a top surface thereof;
a top deck having a planar horizontal upper surface for supporting a quantity of stacked product thereon, the top deck having a mounting surface at an underside surface thereof;
one or more movable support members connected between the bottom platform and the top deck for dynamically adjusting a vertical position of the top deck relative to the bottom platform;
at least one compression member having a first end seated at the mounting surface of the bottom platform and a second end seated at the mounting surface of the top deck, the compression member supplying a lifting force to the top deck in opposition to a weight of the stacked product,
wherein as the weight of the stacked product is reduced due to gradual removal of the stacked product by consumers, the top deck rises to maintain a top layer of the stacked product at a determined height for ease of accessibility by the consumers.

2. The system of claim 1, wherein the bottom platform is fabricated using a vacuum-forming process.

3. The system of claim 1, wherein the compression member comprises a spring.

4. The system of claim 1, wherein the top deck is formed of molded plastic.

5. The system of claim 1, wherein the moveable support ember is a plurality of moveable support members which are configured as cross-braces positioned on opposite sides of the compression member, each of the cross-braces comprising two movable members joined by a pivoting connection at a center portion thereof

6. The system of claim 5, wherein each of the movable members has a guide-pin at an end thereof which is positioned in a slot attached to the top deck or the bottom platform.

7. The system of claim 1, further comprising at least one circular-shaped recess on the underside surface of the top deck and at least one receptacle on the top surface of the bottom platform for receiving the ends of the compression member.

8. The system of claim 1, further comprising a flange formed at an end of the top deck and extending above the planar horizontal surface thereof.

9. The system of claim 1, wherein the compression member is selected to have a determined spring rate which is based at least in part on a weight of the stacked product per unit stacking height.

10. The system of claim 9, wherein the determined spring rate is approximately equal to a weight of a single layer of the stacked product divided by a height of the single layer of the stacked product.

11. The system of claim 9, wherein the compression member is selected to have a determined initial compression force, when positioned between the bottom platform and the top deck, which is based at least in part on the weight of the stacked product per unit stacking height and a determined number of remaining product layers when the top deck is at a maximum height position.

12. The system of claim 1, wherein the compression member is selected to have a determined spring rate and initial compression force, when positioned between the bottom platform and the top deck, for a particular category of stacked product, the category being defined by a weight density range of the product.

13. The system of claim 1, further comprising a surrounding skirt formed of connected panels.

14. The system of claim 13, wherein the panels of the skirt present product information.

15. The system of claim 1, further comprising a shelf back-panel positioned along a side of the bottom platform and top deck to form a shelf section or a shelf end cap, the shelf back-panel including a plurality of vertical tracks to receive at least one shelving unit for positioning over the top deck.

16. The system of claim 1, further comprising a skirt connected about a periphery of the top deck to conceal some of the stacked product.

17. The system of claim 16, wherein said skirt comprises a window for ascertaining inventory of the stacked product.

18. The system of claim 17, wherein said window comprises an opening in the skirt.

19. The system of claim 17, wherein said window comprises a transparent material.
